(19) United States
(12) Patent Application Publication
(10) Pub. No.: US 2004/0034584 A1
(43) Pub. Date: Feb. 19, 2004

(54) System and method for implementing risk management strategies in regulated and/or deregulated energy markets

(76) Inventors: John Raborg Cory SR., Darlington, MD (US); Brian David Bizzano, Alpharetta, GA (US)

Correspondence Address: MINTZ LEVIN COHN FERRIS GLOVSKY AND POPEO PC, 12010 SUNSET HILLS ROAD, SUITE 900, RESTON, VA, 20190, US

(21) Appl. No.: 10/435,595

(22) Filed: May 12, 2003

Related U.S. Application Data
(60) Provisional application No. 60/380,243, filed on May 12, 2002.

(51) Int. Cl. G06F 17/60

(52) U.S. Cl. 705/35

(57) ABSTRACT

A system, method, and computer program product are provided for enabling risk management in regulated and/or deregulated commodity markets through selection of Bundled Utility Services along with volumetric and/or energy commodity risk hedge productsBundled Utility Service. Risk management strategy may be implemented by determining a rate structure associated with a commodity delivered by a Utility and demand information to develop a hedge based on a composite of underlying market quoted products. The invention further provides system and methods for mitigating commodity price risks, Counterparty Credit Risk, and Physical Supply Risks. In one aspect of the invention, a system and method are provided for hedging utility prices associated with varying tariff cost structures, wherein no market product previously existed for tracking tariff cost structures.

### CROSS REFERENCE TO RELATED APPLICATIONS

This application claims priority from U.S. Provisional Application Serial Number 60/380,243, filed on May 12, 2002, the entire contents of which are incorporated herein by reference.

### FIELD OF THE INVENTION

The present invention is directed to a system and method of enabling End Uses to enhance risk management in Regulated and/or Deregulated commodity markets. More specifically, the present invention is directed to enabling End Users to enhance risk management in Regulated and/or Deregulated energy markets by developing a strategy wherein energy End Users contract with Regulated Utilities for Bundled Utility Service to mitigate Physical Supply Risk and Counterparty Credit Risk while contracting with a market participant for a specially structured hedge in order to mitigate Energy Commodity Price Risk and Volumetric Risk that are passed through to the End User by the Utility tariff.

### BACKGROUND OF THE INVENTION

Deregulation and restructuring of the electric power and natural gas industries has invited competition to industries that have traditionally provided near-monopoly status to Utilities operating in predefined regions. In particular, laws, regulations, and orders have been enacted in some jurisdictions permitting Third Party Suppliers to provide Unbundled energy services and energy commodities (“Unbundled Service”) to End Users. Examples include, but are not limited to, Federal Energy Regulatory Commission (FERC) orders, such as FERC Order No. 636, FERC Order No. 888, and FERC Order No. 889, which are hereby incorporated by reference. These orders provide for wholesale and retail energy market deregulation in the United States.

Energy deregulation is directed by the Federal Government, but has proceeded in a patchwork fashion across the United States as various Legislatures adopt deregulation under FERC guidance. Jurisdictions that have adopted legislation permitting deregulation allow Third Party Suppliers and/or energy merchants, for example, to compete with Utilities for the right to provide Unbundled Utility Services to End Users.

In Deregulated markets, End Users may be required to purchase local delivery service from the Utility, but may be able to choose whether to select interstate transmission, commodities and associated services from the variety of Third Party Suppliers.

As a result, energy commodity invoices may still be generated and delivered to End Users by the Utility, with charges being routed to or from corresponding Third Party Suppliers. For example, one Third Party Supplier may provide interstate transmission, another Third Party Supplier may provide local distribution, and yet another Third Party Supplier may provide the energy commodity. The Utility, however, may continue to provide local delivery service, while Third Party Suppliers provide commodity, interstate transmission, and other services to the End Users.

By procuring local delivery, interstate transmission, associated services and/or commodities, etc., from some combination of one Utility and at least one Third Party Supplier, End Users may receive services similar in objective to those received had they been required to procure Bundled Utility Service from a traditional Utility.

Unlike Utilities, however, rates charged by Third Party Suppliers to End Users for energy commodities and services may not be subject to tariff rates set by State Public Utility Commissions. Rather, Third Party Suppliers may procure energy from wholesale energy markets and must decide how much cost to pass along to their customers or End Users so that they may make a reasonable profit and remain competitive. Thus, End Users face the prospect of buying energy commodities at unknown future prices that are governed by the laws of supply and demand rather than regulated entities with predefined profit margins.

In jurisdictions that remain Regulated, End Users may purchase energy commodities only from the Utility. This traditionally Regulated arrangement allows the Utility to offer Bundled Utility Service, wherein End Users must purchase all energy-related commodities and services from the Utility. The invoice generated by the Utility and sent to the End User reflects all the various costs associated with the commodity (e.g., electricity, natural gas, propane, and oil, etc.), including additional costs reflecting, for example, expenditures the Utility invests in distribution systems, assets to accommodate erratic or unexpected End User demand, interstate transmission capabilities, line losses, etc. In such traditional transactions, the Utility may provide End Users with invoices for all of the services and may pass all commodity costs to End Users through base fee rates and Utility Purchase Price Adjustment fees associated with the commodity.

In Regulated or Bundled markets, Utilities may purchase energy commodities from wholesale energy markets and may pass related costs along to End Users. The Utility's ability to pass costs along to End Users is subject to the control of the State Public Utility Commission, which control these rates through tariff mechanisms. Thus, the extent to which actual Utility bills reflect the effects of market prices vary based on the nature of the tariff rate adjustment mechanisms allowed by the Public Utility Commission.

Regardless of whether the End User procures energy in a Regulated or Deregulated market, or whether the End User procures energy from Utilities or Third Party Suppliers, drawbacks exist. For instance, many Third Party Suppliers are not reliable counterparties. Additionally, these Third Party Suppliers generally do not own energy transmission infrastructure, and despite the best efforts of State and Federal regulators to ensure “open access” transmission, Third Party Suppliers may have less reliable physical delivery of energy than Utilities. Finally, Utilities may not be permitted (by regulatory entities) to mitigate the effects of Energy Commodity Price Risk or Volumetric Risk on behalf of End Users.

Additionally, the lack of deregulation, that is or, continued regulation, in some jurisdictions requires End Users to procure Bundled Utility Service. In these cases, End Users face a variety of factors with regard to mitigating various risks. Alternatively, some jurisdictions enable End Users to choose between either Bundled Utility Service or Unbundled Utility Service. Still other jurisdictions permit End Users to contract only for Unbundled Utility Service. The invention is applicable to situations where the End User may be required or may choose to contract for Bundled Utility Service.

While several risk factors may be associated with various aspects of the energy or natural gas industries, the invention only focuses, for exemplary purposes, on mitigating Volumetric Risks, Energy Commodity Price Risks, Counterparty Credit Risk, and Physical Supply Risks. It should be readily appreciated that other risk factors may exist and may also be mitigated through selection of a combination of Bundled Utility Services and Volumetric Risk and/or Energy Commodity Price Risk hedges. Furthermore, while several exemplary embodiments may be disclosed regarding energy and natural gas commodities, it should be readily apparent that the teachings are equally adaptable to other commodities.

Electrical power is a fungible commodity that may be traded in terms of the quantity of the commodity because one unit of the fungible commodity is indistinguishable from another unit of the same fungible commodity. For example, a kilowatt-hour of AC power delivered on a power line is indistinguishable from another kilowatt-hour of AC power delivered at the same time to the same place on the same line. As such, contract specifications may be made standard so that a commodity may be readily exchanged for cash, or its equivalents.

The following definitions are provided for understanding terminology used herein:

a) An Independent System Operator (ISO) may be an entity that monitors the reliability of a power system and coordinates a supply of electricity in a defined geographic area.

b) Energy Merchants may be firms that act as financial or physical intermediaries in the energy markets. Energy Merchants may build, own, or control electrical generation, natural gas transportation and storage, and may provide energy asset management and trading functions. These entities act as market intermediaries by buying energy commodities from production areas and selling them in market areas, as well as making markets and taking positions in markets. A benefit to energy market participants is that liquid markets exist for a variety of energy commodities over a reasonable tenor of forward months.

c) Interstate Pipelines deliver commodities, such as, for example, natural gas or oil, across state lines. The Interstate Natural Gas Pipeline of America is an industry association with links to many example interstate natural gas pipelines.

d) Utilities may be organizations that provide commodities and/or services to energy End Users. In Regulated energy markets, Utilities are vertically integrated and provided services such as, for example, purchasing and controlling fuel transportation, fuel commodities, electrical generation (in the case of electrical Utilities), transmission systems, End User billing, and customer care systems. In Deregulated energy markets, Utilities may continue to exclusively provide certain services to End Users, but may not continue to provide all of their original services. Utilities may continue to bill End Users, for example, even though many charges illustrated on Utility bills may reflect charges for commodities and/or services provided by other Third Party Suppliers.

e) Third Party Suppliers may be organizations competing to serve energy commodities or services to End Users. Third party suppliers may be affiliates of Utilities, affiliates of energy merchants, or independent firms. Regardless, Third Party Suppliers are only allowed to sell energy commodities to End Users in Deregulated markets.

f) Purchase Price Adjustments may be fees or surcharges that Utilities apply against End Users reflecting commodity prices and end user demand for the commodity component of the Bundled Utility service. Purchase Price Adjustments may be included in Utility bills and may be referred to, for example, as the purchased gas cost, purchased fuel adjustment, or the like. Purchase Price Adjustments are Regulated in nature, resulting from action by State Public Utility Commissions (or Public Utility Commissions). As such, tariffs for a particular Utility enable Utilities to charge their End User customers a published rate for the energy commodity the End User buys from the Utility. This rate may be a fixed price per unit delivered or a rate based on a complex formula, producing rates that fluctuate over time. Fluctuations may result from changes in current underlying spot energy market prices, under or over recovery of Regulated rates of return by the Utility in prior periods, unusual demand, etc.

Actual tariff rate structures vary widely by regulatory jurisdiction, Utility, and geographic area. Regardless, tariffs are tools by which Public Utility Commissions enable Utilities to recover a fixed rate of return on assets while ensuring that energy End Users pay a fair and reasonable price for energy. To this end, energy End Users, Utilities, and Public Utility Commissions may each seek to adjust tariff rate mechanisms to their respective benefits (such as Purchase Price Adjustments) from time to time.

Purchase Price Adjustments are more prevalent or important in Regulated energy markets, but tariffs may exist in various forms and, for a variety of purposes, may continue to exist in Deregulated markets.

g) Forward contracts are legally binding agreements to buy or sell a commodity at some time in the future, at a price agreed upon today. Forward contracts may be standardized according to the quality, quantity, delivery time, delivery location, etc., and these standards are generally agreed upon across an industry. Trades may take place in any number of over the counter markets and may settle financially or result in physical delivery of the commodity. Spot prices will prevail during the agreed delivery month that provide an indicator of value, against which the original contract price for the forward may be measured. Ordinarily, forward contracts trade for delivery some months or years prior to the delivery of the contract.

h) Futures contracts may be identical to forwards contracts in many respects but may only be traded on organized commodity exchanges. These exchanges may utilize various contractual provisions to increase market liquidity. Additionally, many exchange-traded products may require financial settlement prior to expiry of the contract. That is, all open interest is closed with participants exchanging net cash payments (or its equivalent) in lieu of actual physical commodities.

i) An Option is a contract giving the holder the right, but not the obligation, to buy (call option) or sell (put option) a futures contract in a given commodity at a specified price at, for instance, the expiry of the option contract.

j) Structured Products are complex products composed of combinations of simple underlying products, and contain complex contractual mechanisms and structures, that are not as readily priced or traded in the same way as a simple product. Structured Products may cover the spectrum of exotic and complex contingent claims. The use of complex economic valuation models, legal advice, and negotiations may be required to settle on an agreement of the resulting price of the contract.

k) An Over the Counter Market (OTC) is a mechanism whereby buyers and sellers of a commodity transact to exchange cash, or its equivalent, for financial or physical energy commodities. Standardization of contract terms allows direct exchange of commodities for cash in an efficient manner. Telephonic based brokers or computerized online order matching systems may enhance traditional telephonic direct counterparty to counterparty trades.

l) An Organized Exchange is an institution offering commodity contracts similar to an OTC market, but with more formalities and rules in order to mitigate counterparty risk and increase market liquidity. These institutions fall under the ambit of the Commodities and Futures Trading Commission (CFTC) regulations.

m) Spot markets comprise a large variety of institutions and mechanisms designed to match energy commodity buyers and sellers that desire to transact on deliveries a specified time period away from the time of the trade. These markets may vary from the massively complex PJM Interconnect to simple OTC markets, where Energy Merchants sell excess power or gas to Utilities directly.

n) Counterparty Credit Risk is the distribution of potential financial outcomes experienced by End Users if contracted Utilities and/or Third Party Suppliers go out of business after the End Users have contracted for future commodity deliveries. Counterparty Credit Risks may also arise from, for example, the counterparty's inappropriate or insufficient business processes, procedures, and/or strategies implemented by Third Party Suppliers. Adverse credit exposure results when an End User contracts with a counterparty for, say a forward contract and then the contract subsequently becomes in the money from the End User's perspective while simultaneously the counterparty defaults on the contracted obligation to the End User. In this case, the End User would be required to re-contract for the same contract specification, but with another counterparty and at a less advantageous price than the original contract.

o) Physical Supply Risk is the distribution of potential financial outcomes experienced by End Users if contracted Third Party Suppliers fail to deliver the contracted commodity. For instance, the End User might contract to deliver natural gas next winter for $6.00/mmBTU. The counterparty the End User contracted with originally may be unable to deliver the natural gas because of an unexpected transmission constraint. As a result, the End User may be forced to procure emergency natural gas from the Utility at a premium rate in view of the last minute purchase.

p) Volumetric Risk is the dispersion of financial outcomes faced by an End User as changes to energy commodity demand fluctuate. For instance, if the End User consumes natural gas to heat a facility, an extraordinarily cold winter may force the End User to consume more natural gas than normal, thereby increasing the heating costs.

q) Energy Commodity Price Risk is the dispersion of financial outcomes faced by an End User due to the distribution of potential future energy commodity prices. For instance, if prices increase in the future, the End User will be required to pay higher prices for the energy commodity, and vice versa.

The invention provides risk mitigation strategies that enable end users to combine the strengths of Regulated and Deregulated markets and to overcome deficiencies of existing market structures, services, and products.

### SUMMARY OF THE INVENTION

The invention overcomes these and other drawbacks of existing systems by providing strategies for simultaneously mitigating Counterparty Credit Risk, Physical Supply Risk, Volumetric Risk, and Energy Commodity Price Risk in Regulated and/or Deregulated energy markets.

The invention also provides systems and methods of structuring contracts and procurement strategies to hedge selected risks that End Users face in Regulated and/or Deregulated energy markets.

The invention further provides systems and methods of enhancing risk management strategy by creating hedges for tariff cost structures in Regulated and/or Deregulated energy markets, wherein the hedges are tied to market products.

The invention also provides systems and methods of enhancing risk management strategy by enabling selection of services from a combination of Bundled Utility Services and Volumetric Risk and/or Energy Commodity Price Risk hedge products Bundled Utility Service.

In an exemplary embodiment, a method and/or computer readable program code are provided for mitigating risks associated with transacting in commodities. A rate structure, associated with each of the commodities, End User tariff rate classes, and Utilities, may be determined, wherein the rate structure may be a fixed price per unit or a variable price per unit. The rate structure may be derived from tariff cost structures or may be based on contractual obligations. End User demand information is also determined for the commodities based on historical trends and may be obtained from several sources. Based at least on the rate structure and the demand information, a hedging strategy may be developed to shield an end user from price or volumetric variations of the underlying commodities that the End User is exposed to in the Utility tariff.

In another exemplary embodiment, a device is provided for mitigating risks associated with transacting in commodities. An input/output device may be used to provide information related to a rate structure determining module that associated the rate structure with the corresponding commodity. The rate structure may be a fixed price per unit or a variable price per unit and may be derived from tariff cost structures or contractual obligations. A demand information module may be provided to receive demand information for the commodities corresponding to the selected end users based on historical trends, or other sources. Based at least on the rate structure and the demand information, a hedging strategy may be developed to shield an end user from price variations of the underlying commodity.

These and other features and advantages of the invention will become apparent through out the detailed description of various embodiments and the drawings attached hereto. It is also to be understood that both the foregoing general description and the following detailed description are exemplary and not restrictive of the scope of the invention.

### BRIEF DESCRIPTION OF THE DRAWINGS

Numerous other objects, features, and advantages of the invention should now become apparent upon a reading of the following detailed description when taken in conjunction with the accompanying drawings, a brief description of which is included below. Additionally, it should be noted these drawings represent abstractions of very complex market structures that, by the orders of complexity involved, must be simplified for reasonable review.

FIG. 1 illustrates a chart of parties that deliver transmission, commodities, and services in both regulated and unbundled electricity markets;

FIG. 2 illustrates a chart of delivery mechanisms for transmission, commodities, and services in both the regulated and unbundled natural gas markets;

FIG. 3 illustrates a chart summarizing risk exposure faced by end users contracting with vertically integrated utilities and third party suppliers;

FIG. 4 illustrates a chart having historical month data and corresponding purchase price adjustment rates;

FIG. 5 illustrates an exemplary embodiment of a system diagram for the present invention; and

FIG. 6 illustrates a flow chart for developing a hedging strategy according to the present invention.

### DETAILED DESCRIPTION OF THE INVENTION

End Users may be required to contract for Bundled Utility Service or may be required to select from a combination of Bundled Utility Services and Unbundled Utility Services. In either case, the selections that are presented to End Users each include distinct risks that the invention is capable of managing. Specifically, the invention provides a strategy enabling End Users to mitigate Counterparty Credit Risk and Physical Supply Risk by contracting for Bundled Utility Service from a Utility. Additionally, the invention provides mechanisms that enable End Users to mitigate Volumetric Risk and Energy Commodity Price Risk.

FIG. 1 illustrates a chart 100 having a column 102 that represents the stages of fuel procurement, generation, transmission, commodity delivery, and services, along with associated columns 104, 106 that represent parties which perform the activities of column 102 in regulated and unbundled electricity markets.

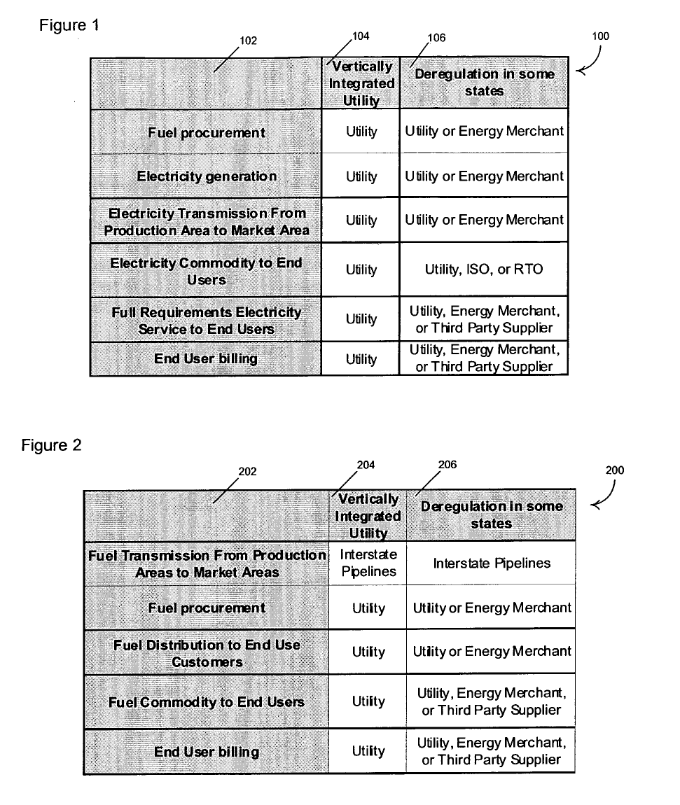

FIG. 2 illustrates a chart 200 having a column 202 that represents the stages of fuel procurement, generation, transmission, commodity delivery, and services, along with associated columns 204, 206 that represents parties which perform the activities of column 202 in regulated and unbundled natural gas markets.

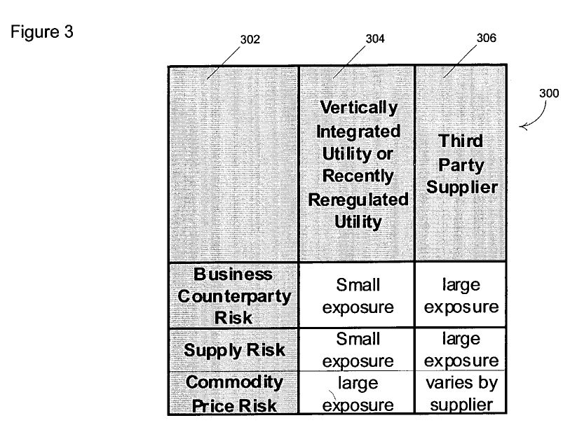

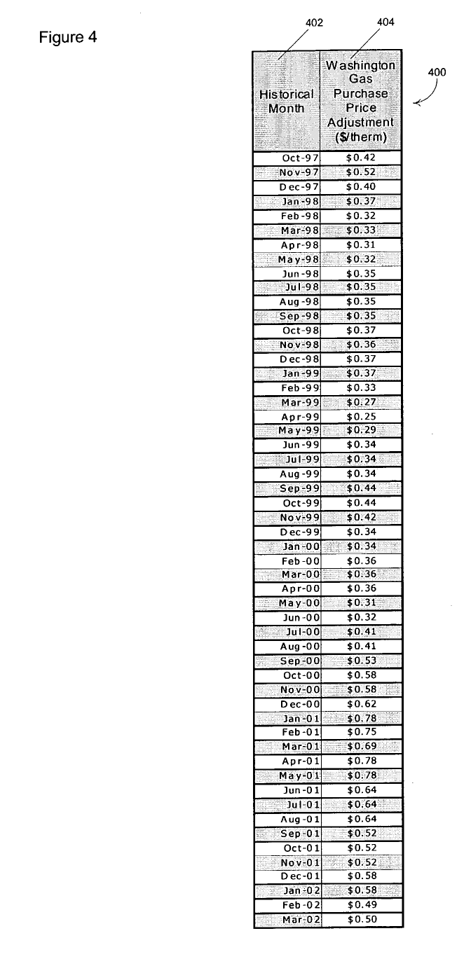

While several risk factors may be associated with financial aspects of the energy and natural gas industries, the invention focuses, for exemplary purposes, on mitigating Volumetric Risks, commodity price risks, Counterparty Credit Risk, and Physical Supply Risks. FIG. 3 illustrates a chart 300 including risk column 302 and summarizing the risk exposure faced by end users contracting with vertically integrated utilities 304 and third party suppliers 306. It should be readily appreciated that other risk factors may exist and may also be mitigated through selection of a combination of Bundled Utility Services and Volumetric Risk and/or Energy Commodity Price Risk hedges Bundled Utility Service. Furthermore, while several exemplary embodiments are directed to energy and natural gas commodities, it should be readily apparent that these teachings are equally adaptable to other commodities.

The invention provides a Counterparty Credit Risk strategy whereby End Users contract, or continue contracting with a Utility for Bundled Utility Service. The act of contracting with another party creates Counterparty Credit Risk for the End User. As a result, mitigating Counterparty Credit Risk is one of degree, so End Users prefer to contract with a more financial stable counterparty as compared to a less financially stable counterparty.

Utilities are relatively financially stable counterparties because they are generally allowed to generate a regulated rate of return on their assets. For example, if the Utility generates a lower rate of return in one period, the Utility may be permitted by the Public Utility Commission to earn a greater rate of return in a next period to make up for the previous period's deficit. Utilities may pass the variable costs of business to End Users through a Purchase Price Adjustment.

In contrast, Third Party Suppliers are traditionally less financially stable because they are susceptible to market forces. For instance, ENRON CORPORATION provides an example of a corporation that declared bankruptcy while having forward contract requirements and commitments to End Users and/or to energy merchant counterparties.

In another example, an End User may decide to purchase natural gas from a Third Party Supplier during some future month at a fixed price. During the particular delivery month, natural gas prices may increase dramatically because of a transportation constraint or bottleneck. While the Third Party Supplier contracted to sell natural gas to the End User at a fixed-price that is below current spot prices, the Third Party Supplier may not have hedged the purchase and may not have the financial resources to purchase the natural gas at the current spot prices. The unhedged price commitments may financially overwhelm the Third Party Supplier because the associated liabilities exceed available assets and the Third Party Supplier may be forced declare bankruptcy. In this scenario, the End User may not receive natural gas at the contracted lower fixed price and may therefore be forced to purchase natural gas at the prevailing higher current spot market price.

From a cost perspective, End Users might be tempted to contract with Third Party Suppliers to take advantage of competitive market forces. However, contracting with a Third Party Supplier may dramatically increase an End User's Counterparty Credit Risk. To mitigate Counterparty Credit Risk, the invention provides that the End User contract, or continue contracting, with the appropriate Utility for Bundled Utility Service Counterparty Credit Risk.

Regarding Physical Supply Risk mitigation strategy, the invention again provides that the End User contract, or continues contracting, with the Utility for Bundled Utility Service. Since Utilities are required by law to maintain prudent Utility practice regarding reliable delivery of energy commodities, the Utility is likely to meet End User demand and thereby avoid placing additional costs on the End User, which may draw action from Public Utility Commissions. To this end, an underlying tenant of most Utilities is the obligation to serve End Users and to be the supplier of last resort for End Users.

Physical Supply Risks also may arise, for example, if the commodity is not delivered as contractually promised or the commodity delivery does not meet the contractually required specifications including, but not limited to, price, quality, quantity, timing, and/or location. Therefore, a counterparty that is contractually required to deliver a commodity may avoid declaring bankruptcy or may avoid financial peril resulting from a failure to deliver the contracted commodity because the inability to deliver a commodity might be contractually excused through force majeure. However, if the counterparty fails to deliver the commodity, the End User may be exposed to purchasing replacement commodities in the market, at elevated prices.

Additionally, in cases where Utilities continue to own energy commodity transmission and/or transportation infrastructure, Third Party Suppliers may not be granted equal access to these assets despite legislative mandates. Thus, Utilities may continue to benefit from superior delivery reliability over Third Party Suppliers due to internal control mechanisms, policies, and procedures.

In an illustrative example, an End User may arrange to purchase natural gas from a Third Party Supplier. During a particular delivery month, natural gas prices may increase dramatically as a result of a transportation constraint or bottleneck. The Third Party Supplier may not own any natural gas transportation assets through the bottleneck and therefore may not be able to transport the natural gas past the constraint for delivery to the End User. As a result, the End User may not receive the contracted gas from the Third Party Supplier and may need to arrange for an emergency gas purchase from the Utility at elevated rates.

Counterparty Credit Risk Physical Supply Risk Another aspect of the invention is directed to volumetric and Energy Commodity Price Risk mitigation strategies. The invention provides volumetric and Energy Commodity Price Risk hedging products whose payoff functions are specially structured to mitigate End User's economic exposures to Utility tariff rates for energy commodities.

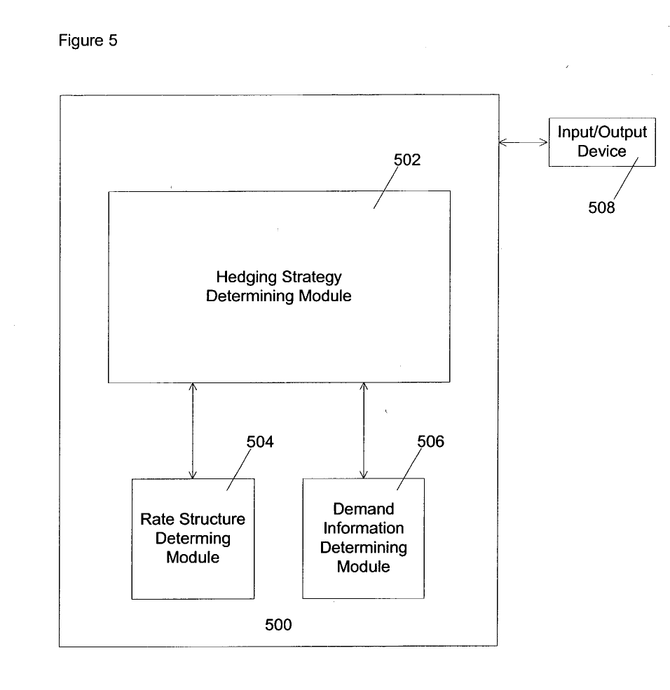

FIG. 5 illustrates an exemplary embodiment of a system 500 for mitigating risks associated with commodity transactions. An input/output device 508 enables entry of information to rate structure determination module 504 and demand information determination module 506. A hedging strategy determination module 502 may be coupled to rate structure determination module 504 and demand information determination module 506 for developing a hedge strategy based at least on the rate structure information and the demand information. The results of the hedge strategy may be provided to the end user through the input/output device 508.

Other aspects of the invention provide for using weather derivative or insurance contracts, for example, to mitigate Volumetric Risk, which is essentially variability in End User energy costs driven by changes in climactic variables. Volumetric Risks may exist if an End User's expected energy commodity demand has some degree of variability around an expectation. If, for example, cold weather forces the End User to procure more natural gas for heating, the End User's total energy commodity costs may subsequently increase because the End User must procure more units of the commodity.

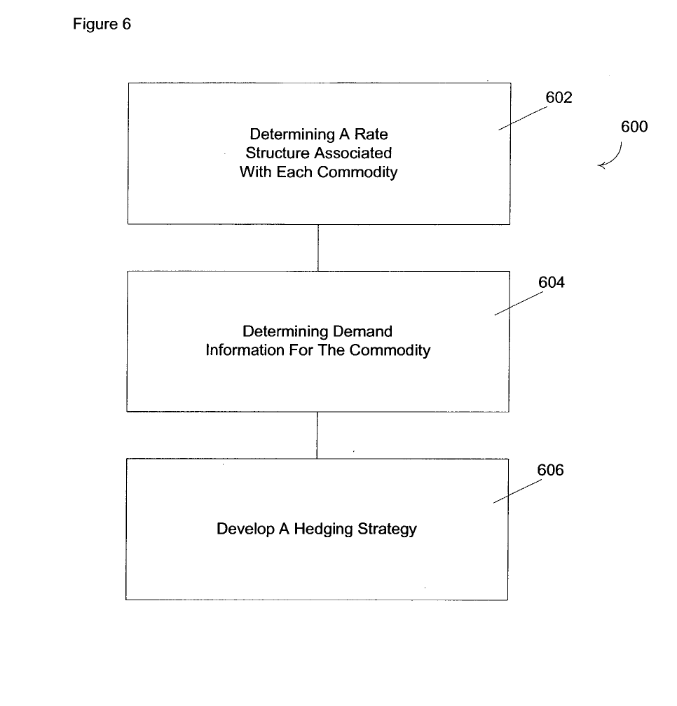

FIG. 6 illustrates that a rate structure associated with a commodity may be determined at step 602 and demand information may be determined at step 604. Based on this information, a hedging strategy may be developed at step 606. More particularly, the fixed price per unit may be determined from the utility tariff and the historical energy demand information may be determined from the end user, if the end user receives energy from a regulated utility. Alternatively, the fixed price per unit may be determined from the contract between the end user and the third party supplier, if the end user receives energy from a third party supplier. Using these pieces of information, for example, a volumetric hedge may be constructed for the end user using market quoted products. This hedge may be constructed from many combinations of, for example, traded contracts, investments, physical assets or liabilities, transactions, securities, weather derivatives, etc.

In another exemplary embodiment for constructing a Volumetric Risk hedge, Volumetric Risk the invention provides for the End User to contract, or continue contracting with a Utility for Bundled Utility Service. and to analyze the Utility tariff to understand how Volumetric Risks are passed through the tariff to the particular End User. For example, the Utility tariff may require the End User to pay the Utility one fixed rate per mmBTU of natural gas consumed. This rate may be constant during the effective duration of the tariff. However, if the End User consumes more natural gas, the End User's total commodity cost may increase. Alternatively, if the End User consumes less natural gas, the End User's total commodity cost may decrease.

The invention further calls for one to understand factors that drive changes in the End User's natural gas demand. For example, an End User may require natural gas for heating, in which case colder weather increases the End User's natural gas consumption. Alternatively, hot weather may increase an End User's consumption of electricity for cooling. Finally, business cycles may increase or decrease a process facility's demand for input stock, such as, for example, natural gas or electricity.

Based on the rate structure and demand information, for example, projections of the End User's energy commodity consumption may be developed. This projection may include developing a distribution of potential energy commodity consumption for each of a period of numerous future months. This distribution may also possess various moments, such as a mean (expectation), variance, standard deviation, skewness, and/or kurtosis, etc.

The distributions of potential energy commodity consumption may be combined with rate structure and demand information to develop an understanding of the End User's economic sensitivity to changes in underlying climactic and/or business cycle variables. This may result in another set of distributions, for example, of an End User's total energy commodity costs, given an input price that is fixed per unit of consumption.

Another aspect of the invention involves gaining an appreciation for aspects of these total energy commodity cost distributions that the End User may want to hedge against. Since all End Users are not equally risk averse, some End Users may desire only to hedge against extreme climactic events. In this case, out-of-the money weather call options may be appropriate. In other cases, an End User may desire to completely eliminate Volumetric Risks and may therefore find buying an at-the-money weather call and buying an at-the-money weather put to be a desirable Volumetric Risk strategy. The objective is to use weather derivatives, or some other volumetric hedging product, to develop a product whose value changes in roughly equal and opposite measure to changes in the portions of an End User's energy commodity costs that can be attributed to changes in climactic variables or business cycles.

After developing a Volumetric Risk hedging strategy, the invention provides a strategy for End Users to mitigate economic risks associated with Energy Commodity Price Risks.

For many energy commodities, such as electricity and natural gas, uncertain weather and resulting effects on demand along with unexpected forced outages of critical transmission or generation equipment and resulting uncertain effects on supply may cause great uncertainty as to what spot prices will eventually prevail after spot markets clear. Therefore, For Energy Commodity Price Risk mitigation strategy provides for the End User to contract, or continue contracting with the Utility for Bundled Utility Service.

The invention further provides for a review of the Utility's tariff to understand the role and nature of the Purchase Price Adjustment and how market based risks are passed through the tariff to the End User.

Generally, neither energy sellers, such as producers or Energy Merchants, or energy purchasers, such as Third Party Suppliers and Utilities, are consistently able to successfully forecast energy commodity prices that will prevail in spot markets at a future time (e.g., months, years, days, or hours). This inability to control and/or accurately predict factors effecting future commodity prices has given rise to hedging in financial and physical energy markets as a way of mitigating Energy Commodity Price Risk.

Corporations that are not Utilities mitigate Energy Commodity Price Risk through extensive and active risk management regimes whereby energy commodities are transacted upon, to the net effect of creating a combination of risk and return to be desirable to that corporation. In contrast, Utilities are often prevented from transacting on commodity products that hedge risks.

Rather, Public Utility Commissions have traditionally used a tariff as a mechanism to enable Utilities to recover a regulated rate of return while protecting End Users against extreme price changes. As such, Utilities may be protected by the fact that they tend to buy commodities at a price and are allowed to resell that exact volume the Utility purchased at the exact price the Utility paid for the commodity, or some other similar mechanism. As a result, if commodity prices increase or decrease, the Utility is shielded from adverse economic impacts because it may sell its product at guaranteed prices.

The End User that contracts with a Utility for Bundled Utility Service, on the other hand, is therefore exposed to Energy Commodity Price Risk. The Utility may have no incentive or capability to hedge against adverse energy commodity price moves, since the Utility is secure in its ability to pass along to End Users whatever prices happen to be at the time. As such, the Utility might pass along high or low prices to the End User, which may not be suitable for risk averse End Users.

As a result, the Energy Commodity Price Risk mitigation strategy provides for developing a distribution of forecasted energy consumption similar to that of the Volumetric Risk strategy development process. Energy Commodity Price Risk may involve developing an economic sensitivity analysis of expected energy commodity consumption combined with potential energy commodity price distributions. A rough estimate, for example, may be performed with a Monte Carlo or Value at Risk type approach that is common in the industry. A distinction between the Energy Commodity Price Risk mitigation strategy and the Volumetric Risk mitigation strategy is that in Energy Commodity Price Risk mitigation strategy focuses on expected energy commodity consumption and the distribution of potential energy commodity prices. In the case of Volumetric Risk mitigation, the focus is on the distribution of potential energy commodity consumption taken together with a fixed price exposure per unit consumed.

A next step is to develop a sense of the End User's risk tolerance as it pertains to the distribution of potential financial outcomes when taking the expectation of energy commodity demand with the distribution of potential energy commodity prices. As with the Volumetric Risk mitigation process, different End Users have different risk tolerances. Some may want to hedge only the tails of the distribution, others all Energy Commodity Price Risk.

To this end, information gained in the analysis of Energy Commodity Price Risk process is used to construct a structured product whose value changes in roughly equal magnitude and opposite direction to changes in the End User's energy commodity costs.

For example, an End User Energy Commodity Price Risk may contract with a Utility for Bundled Utility Service. Although the End User may pay a tariff-based rate to the Utility for natural gas rather than market-based prices, the Utility may purchase natural gas at market-based prices. Typically, the End User's Utility will pass the cost of natural gas on to the End User via the Regulated tariff rate structure, which reflects the nature of the Utility's natural gas purchasing habits. In this case, the End User may pay for the Utility for the natural gas through a weighted average cost of natural gas specified in a tariff.

In one example, the End User may consume the same amount of natural gas each day, regardless of climactic or business conditions. If interstate natural gas pipelines connect in two locations to the Utility intrastate gas pipeline, the Utility may purchase natural gas from the market at both of these locations to supply its various End Users.

In this example, the Regulated tariff rate allows the Utility to charge End Users a weighted average of ⅔ times the market price at location A and ⅓ times the market price at location B for all units of natural gas delivered to the End User. If the market price at location A is $4.00/mmBTU and the market price for location B is $8.00/mmBTU, then the weighted average price the Utility may charge the End User that day would be approximately $5.33/mmBTU. Due to the unique method of calculating this Regulated tariff rate, there is no one market product that could be procured to reasonably hedge the End User's Energy Commodity Price Risk. Rather, the Energy Commodity Price Risk process may be used to develop a reasonable portfolio of products that, when taken in total, enable the End User to mitigate Energy Commodity Price Risk passed through the End User by the Utility tariff.

Volumetric Risk, Energy Commodity Price Risk, Physical Supply Risk, and Counterparty Credit Risk are all related. In a case where energy commodity prices increase dramatically due to an unseasonably cold winter, natural gas volume demanded may increase dramatically. Additionally, Counterparty Credit Risk may increase as certain counterparties are forced to buy very high priced natural gas in order to meet their obligations. Some of these counterparties may go into bankruptcy. Further, high natural gas demand may strain the ability of the transmission system to get gas to End Users. Some transmission systems fail, and/or certain Third Party Suppliers are unable to use Utility transmission systems in time of need so that End Users may be forced to procure high priced emergency gas from the Utility. Finally, End Users may be forced to pay for high priced natural gas if they did not hedge Energy Commodity Price Risks. As such, the conditional probability of End Users facing real losses due to any one of the risks mentioned herein is higher given the existence of real losses due to another of the risks mentioned herein.

The invention improves End User risk energy management capabilities by providing End Users with a unique combination of Bundled Utility Service along with Volumetric Risk and/or Energy Commodity Price Risk hedging. Through this combination, the invention simultaneously mitigates at least Counterparty Credit Risk, Physical Supply Risk, as well as volumetric and/or Energy Commodity Price Risk. By simultaneously mitigating these risks, End Users are rewarded with increased financial certainty, improved ability to budget and plan for the future, and improved assurance that energy costs will be relatively stable over the tenor that the invention is implemented, as well as enhanced counterparty credit worthiness and improved Physical Supply Risk mitigation.

While this invention has been described with what is presently considered to be most practical and preferred embodiment, it is understood that this invention is not limited to the disclosed embodiment. Rather, it is intended to cover various modifications within the spirit and scope of the disclosure.

What is claimed is:

1. A method of mitigating risks associated with transacting in commodities, comprising:
determining a rate structure associated with each of the commodities;
determining demand information for the commodities; and
developing a hedging strategy based at least on the rate structure and the demand information.

2. The method according to claim 1, wherein determining the rate structure comprises obtaining underlying components of a tariff-based rate structure.

3. The method according to claim 1, wherein determining the rate structure comprises obtaining components from a contracted rate structure.

4. The method according to claim 1, wherein determining the rate structure comprises obtaining a weighted average of a contracted rate structure.

5. The method according to claim 1, wherein developing the hedging strategy comprises assembling market quoted products.

6. The method according to claim 5, wherein the market quoted products comprise at least one of traded contracts, investments, physical assets, physical liabilities, transactions, securities, and weather derivatives.

7. The method according to claim 1, further comprising aggregating demand information from a plurality of end users to develop the hedge strategy.

8. The method according to claim 1, further comprising selecting at least one supplier from which to transact in the commodities based on a rating of the at least supplier.

9. The method according to claim 8, wherein the at least one supplier is a regulated utility.

10. The method according to claim 1, further comprising selecting at least one supplier from which to transact in the commodities based on an ability to deliver the commodities.

11. The method according to claim 10, wherein selecting the at least one supplier comprises selecting a regulated utility.

12. A device for mitigating risks associated with transacting in commodities, comprising:
a rate structure determining module, associated with each of the commodities, that is adapted to determine a rate structure of each commodity;
a demand information determining module, associated with selected end users, that is adapted to determine demand information for the commodities corresponding to the selected end users; and
a hedging strategy developing module in communication with the rate structure determining module and the demand information determining module that is adapted to develop a hedge based at least on the rate structure and the demand information.

13. The device according to claim 12, wherein the rate structure determining module is adapted to obtain underlying components of a tariff-based rate structure.

14. The device according to claim 12, wherein the rate structure determining module is adapted to obtain components from a contracted rate structure.

15. The device according to claim 12, wherein the hedging strategy developing module is adapted to develop hedging strategy using market quoted products.

16. A device for mitigating risks associated with transacting in commodities, comprising:
rate structure determining means for determining a rate structure of each commodity;
demand information determining means, associated with selected end users, for determining demand information for the commodities corresponding to the selected end users; and
hedging strategy developing means for developing a hedge based at least on the rate structure and the demand information.

17. The device according to claim 16, wherein the rate structure determining means obtains underlying components of a tariff-based rate structure.

18. The device according to claim 16, wherein the rate structure determining means obtains components from a contracted rate structure.

19. The device according to claim 16, wherein the hedging strategy developing means develops hedging strategy using market quoted products.

20. A computer readable medium having computer readable program code embodied therein for mitigating risks associated with transacting in commodities, comprising:
computer-readable program code for causing a computer to determine a rate structure associated with each of the commodities;
computer-readable program code for causing the computer to determine demand information for the commodities; and
computer-readable program code for causing the computer to develop a hedging strategy based at least on the rate structure and the demand information.
